(19) United States
(12) Patent Application Publication
(10) Pub. No.: US 2010/0308255 A1
(43) Pub. Date: Dec. 9, 2010

(54) DEICER SALT SHAPED FORMS

(76) Inventors: Mark L. ROBERTS, Wyckoff, NJ (US); Robert S. ENGLISH, Wrentham, MA (US)

Correspondence Address: LAHIVE & COCKFIELD, LLP;FLOOR 30, SUITE 3000, ONE POST OFFICE SQUARE, BOSTON, MA, 02109, US

(21) Appl. No.: 12/477,585

(22) Filed: Jun. 3, 2009

(51) Int. Cl. C09K 3/18

(52) U.S. Cl. 252/70

(57) ABSTRACT

A deicer salt having a predetermined geometric shape such as a cube, a pyramid, a parallelepiped, etc. melts ice and/or snow accumulations on surfaces. The deicer salt has a solid shaped form with a volume of about 25-225 mm³. The three dimensional deicing solid shaped form has an aspect ratio of between about 0.5 and about 1.5. The deicer salt shaped form may be produced using pre-formed molds into which a molten or concentrated deicing liquid may be poured. The deicing liquid is then hardened into the shape of the pre-formed mold resulting in solid shaped form deicer salt having a pre-determined geometric shape. Alternatively, powder or fine-particle solid form of the deicer salt may be compacted into the pre-formed molds to form the solid deicer salt shaped form. The deicer salt shaped form has a uniform shape, size and consistency.

### FIELD OF THE INVENTION

The present invention relates generally to a shaped salt having a pre-determined shape for melting ice and/or snow, and more particularly to a solid deicer salt shaped form comprising a plurality of planar sides and having a pre-determined geometric shape including, but not limited to, a cube, a pyramid, and a parallelepiped.

### BACKGROUND OF THE INVENTION

Deicers are widely used on walkways, driveways, parking lots, and the like to melt snow and/or ice formed on the surface thereof. For example, in the United States, over 21 million tons of deicing materials were used in the winter of 2007/2008. Conventional deicers can be in liquid form or in solid form. The present invention concerns solid deicers. The solid deicers are generally made of sodium chloride and products such as calcium chloride, magnesium chloride and potassium chloride, which are characterized herein as premium deicers. These premium deicing materials have improved melting performance compared to sodium chloride. The solid deicers may also be formed of urea, calcium magnesium acetate, sodium acetate and sodium formate that have less corrosive characteristics than the sodium chloride. The solid deicers may further be formed from mixes of various salts such as calcium, magnesium, potassium, and sodium chlorides.

Conventional deicers have many drawbacks that decrease their efficiency. For example, conventional deicers are prone to being blown away by wind while in the air or even after being deposited on a surface. Moreover, some conventional deicers cannot bore through ice and/or snow effectively. Boring capability is an important feature of the deicers. When a deicing particle bores through ice and/or snow, the deicing particle travels through the layer of ice and/or snow to the solid surface and forms a brine layer between the solid surface to be deiced and the ice and/or snow piled above it, promoting breakup and melting of the snow and/or ice. However, some conventional deicers do not bore through the ice; instead they remain on top, and are minimally effective. In addition, some conventional deicers are susceptible to rolling on inclined surfaces. The effectiveness of these deicers is reduced because they roll off of the surface requiring deicing.

Accordingly, what is needed is a deicer salt that is resistant to wind, both while airborne and while on a surface, is resistant to rolling away on inclined surfaces, and has good boring capability. The present invention is directed to addressing these needs, in addition to other characteristics.

### SUMMARY OF THE INVENTION

In accordance with one embodiment of the present invention, a solid deicer salt shaped form has a pre-determined geometric shape with a plurality of planar surfaces. The pre-determined geometric shape may be one of a cube, a pyramid, a parallelepiped, etc. The deicer salt formed by controlling the shape of each deicer salt particle is resistant to the influence by wind while airborne, i.e. the deicer salt particles are not blown away by wind before reaching the ground during the spreading process. The deicer salt described herein is also resistant to rolling after being deposited on the surface to be deiced, i.e. the deicer salt particles do not roll away on surfaces in windy environments or on inclines. The shaped deicer salt is also sized to effectively bore through the ice and/or snow.

According to aspects of the present invention, a deicer salt shaped form that is adapted to melt snow and ice is provided. The deicer salt shaped form has a pre-determined three dimensional geometric shape having aspect ratios of length to width, length to height, and width to height, each between about 0.5 and about 1.5. The deicer shaped form may also have a plurality of planar surfaces, each having a drag coefficient greater than 0.47. The deicer salt shaped form may also have a contact surface area between 9 mm² and 36 mm². The contact surface area is one of the plurality of planar surfaces on which the deicer salt shaped form rests stable on a surface to be deiced. The pre-determined geometric shape can be one of a cube, a pyramid and a parallelepiped. The deicer salt shaped form can have a volume of about 25-225 mm³.

According to aspects of the present invention, a method of preparing a deicer salt shaped form is provided. The method includes providing at least one mold cavity having a geometric shape. A liquid deicer salt solution is introduced into the at least one mold cavity. The liquid deicer salt solution is hardened in the at least one mold cavity to create the deicer salt shaped form. The deicer salt shaped form is removed from the at least one mold cavity. The method may also include, after introducing the liquid salt solution into the mold cavity, removing excess of the liquid salt solution for uniformly dispersing the liquid salt solution within the mold cavity. The at least one mold cavity may be flexible. The mold system may include a plurality of mold cavities each having a geometric shape.

According to aspects of the present invention, a method of preparing a deicer salt shaped form having a predetermined shape is provided. The method includes providing at least one mold cavity having a geometric shape including a cube, a pyramid or a parallelepiped. A fine particle deicer salt composition is compacted into the at least one mold cavity to create the deicer salt shaped form. The deicer salt shaped form is removed from the at least one mold cavity.

According to aspects of the present invention, a deicer salt shaped form is provided. The deicer shaped form has a first substantially planar surface formed in a predetermined shape having predetermined size and dimensions and a second substantially planar surface formed in a predetermined shape having predetermined size and dimensions and intersecting with the first substantially planar surface. The deicer shaped form also has a third substantially planar surface formed in a predetermined shape having predetermined size and dimensions and intersecting with at least the first substantially planar surface and the second substantially planar surface. The deicer shaped form further has a fourth substantially planar surface formed in a predetermined shape having predetermined size and dimensions and intersecting with at least one of the first, the second, or the third substantially planar surfaces. The first, the second, the third, and the fourth substantially planar surfaces combine to form at least a portion of a pre-determined three dimensional geometric shape. The three dimensional geometric shape has aspect ratios of length to width, length to height, and width to height, each between about 0.5 and about 1.5. The three dimensional geometric shape is adapted to melt snow and ice.

### BRIEF DESCRIPTION OF THE DRAWINGS

The present invention will become better understood with reference to the following description and accompanying drawings, wherein:

FIG. 1A illustrates a plurality of exemplary geometric shapes of the deicer salt shaped forms according to various aspects of the present invention;

FIG. 1B illustrates a cube and a modified cube having the same dimensions;

FIG. 2A is an exemplary mold system according to an embodiment of the present invention;

FIG. 2B is an exemplary mold system according to another embodiment of the present invention;

FIG. 3 illustrates an exemplary deicer salt according to an aspect of the present invention and a conventional deicer salt on an inclined slope;

FIG. 4 is a flowchart illustrating an exemplary process to manufacture the deicer salt from a liquid deicer salt composition according to an embodiment of the present invention; and

FIG. 5 is a flowchart illustrating an exemplary process to manufacture the deicer salt from a fine particle deicer salt composition according to another embodiment of the present invention.

### DETAILED DESCRIPTION

An illustrative embodiment of the present invention relates to an improved deicer salt having a predetermined geometric shape such as a cube, a pyramid, a parallelepiped, etc. for melting snow and/or ice. The deicer salt may be formed of calcium chloride, magnesium chloride, potassium chloride, urea, calcium magnesium acetate, sodium acetate, sodium formate or combinations as a single form of any other deicer composition. Other types of solid deicer salt compositions are considered within the scope of the invention. The deicer salt according to various embodiments of the present invention has a solid shaped form with a volume of about 25-225 mm³. Preferably, the deicer salt has a solid shaped form with a volume of about 64 mm³. The deicer salt, according to various embodiments of the present invention, has an aspect ratio of between 0.5 and 1.5. The aspect ratio of a shape is the ratio of its longest dimension to its shortest dimension. The dimensions of a three dimensional shape are the height, width, and length of the three dimensional shape. As used herein the aspect ratio is determined as the ratio of the overall height to the overall width, the ratio of the overall height to the overall length, or the ratio of the overall width to the overall length. A drag coefficient of the deicing shaped form depends on which surface of the deicing shaped form faces the wind. The drag coefficient of each planar side of the deicing shaped form produced according to the present invention is at least 0.5. These properties allow the deicer salt shaped form to resist being blown away by the wind while airborne or even after being deposited on the icy surface. The deicer salt shaped form has enough mass, relative to surface area, to bore through the icy surface once the deicer salt shaped form comes to rest on one of its planar surfaces on the icy surface.

The deicer salt shaped form according to various embodiments of the present invention may be produced using pre-formed molds into which a molten, or concentrated deicing liquid may be poured. The deicing liquid is then hardened into the shape of the pre-formed mold resulting in solid shaped form deicer salt having a pre-determined geometric shape with desirable physical dimensions and properties. According to various aspects of the present invention, powder or fine-particle solid form of the deicer salt may be compacted into the pre-formed molds to produce the solid deicer salt shaped form. The deicer salt shaped form manufactured according to the present invention has a uniform shape, size and consistency.

As referred to herein, the deicer salt shaped form has a plurality of planar surfaces. The term “planar” and “substantially planar” are used interchangeably herein and relate to a surface having substantially two dimensions without significant surface features or surface variability. To the extent that the surface of a planar surface has variability, the dimensions of that surface variability are insignificant relative to the overall size of the planar surface. The concept of planar, as embodied herein, relates to a surface that is substantially flat, is not bowed or curved, does not contain substantial projections or depressions of significant extension or depth, and generally appears to be smooth or mildly rough. A “planar surface” will generally rest in a balanced and consistently repeatable manner if placed face down on a smooth horizontal surface.

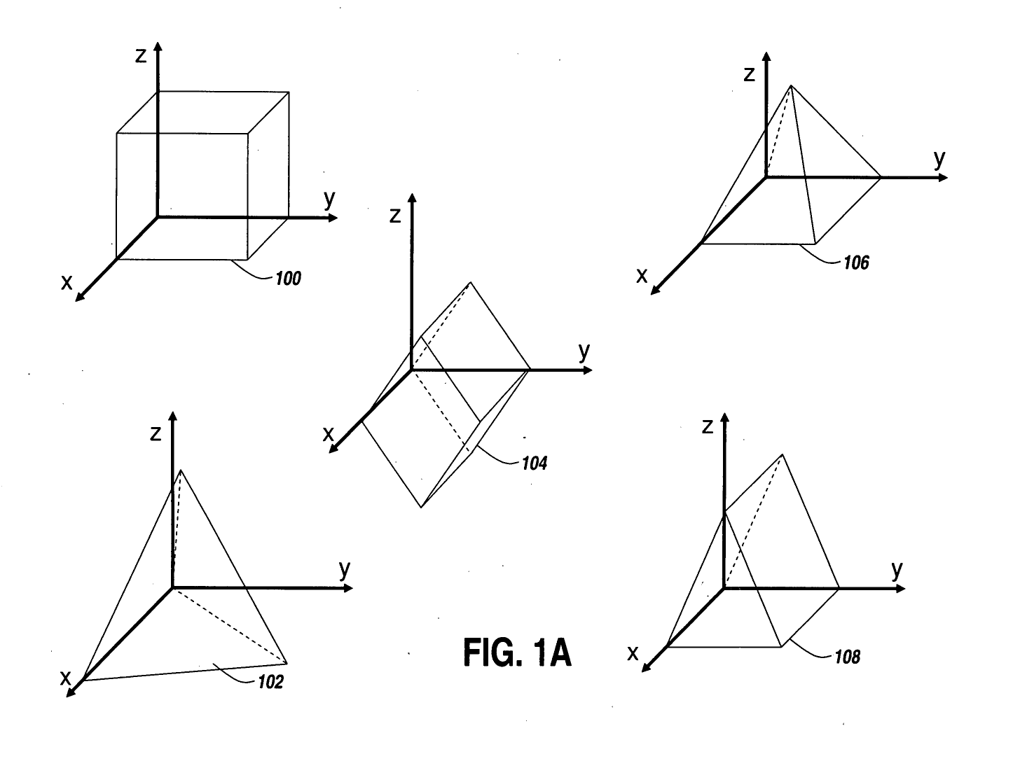

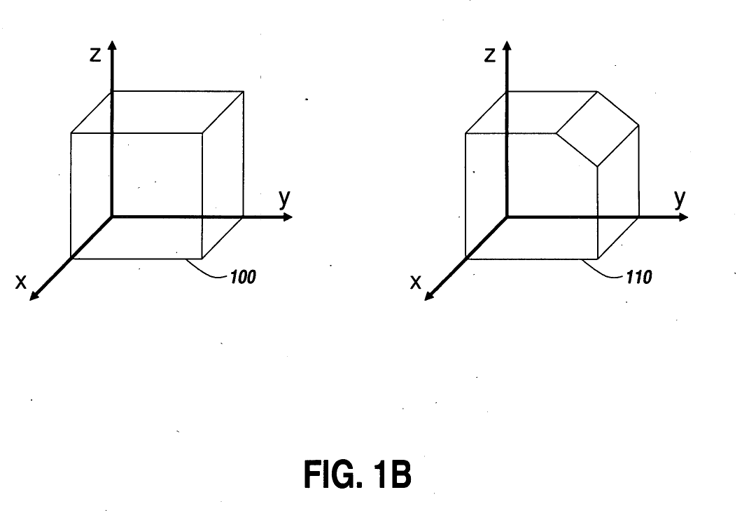

FIGS. 1A through 5, wherein like parts are designated by like reference numerals throughout, illustrate example embodiments of a deicer salt shaped form having a predetermined geometric shape according to the present invention. Although the present invention will be described with reference to the example embodiments illustrated in the figures, it should be understood that many alternative forms can embody the present invention. One of ordinary skill in the art will additionally appreciate different ways to alter the parameters of the embodiments disclosed, such as the size, shape, or type of elements or materials, in a manner still in keeping with the spirit and scope of the present invention.

FIG. 1A illustrates various geometric shapes having a plurality of planar surfaces, i.e. a cube 100, a triangular pyramid 102, a parallelepiped 104, a rectangular pyramid 106 and a prism 108. A deicer salt shaped form according to present invention may be formed in any of the geometric shapes illustrated in FIG. 1A, or variations thereof. However, one of ordinary skill in the art will appreciate that the geometric shapes having a plurality of planar surfaces are not limited to those illustrated in FIG. 1A and that the deicer salt shaped forms in other pre-determined geometric shapes are also within the scope of the present invention. A deicer salt shaped form having a plurality of planar sides, such as those illustrated in FIG. 1A, has a plurality of advantages over the conventional deicer salts.

FIG. 1A further illustrates how the dimensions of the deicer salt cast may be determined. As provided above, the deicer salt cast according to various embodiments of the present invention has an aspect ratio of between 0.5 and 1.5, and preferably between 0.7 and 1.4. The aspect ratio of a shape is the ratio of its longer dimension to its shorter dimension. The dimensions of a three dimensional shape are the height, the width, and the length of the three dimensional shape. As used herein, the aspect ratio is determined as the ratio of the overall height to the overall width, the ratio of the overall height to the overall length, or the ratio of the overall width to the overall length. The dimensions of a three dimensional shaped form are measured by placing the three dimensional shaped form at the origin of a three dimensional Cartesian coordinate system, as illustrated in FIG. 1A. The longest distance along the z-axis is the height, the longest distance along the y-axis is the length and the longest distance along the x-axis is the width. The ratio of these dimensions to each other is between 0.5 and 1.5, and preferably between 0.7 and 1.4.

The geometric shapes illustrated in FIG. 1A are, classic geometric shapes such as a cube, a pyramid, a parallelepiped, etc. However, deformations or modifications of these geometric shapes are also within the scope of the present invention. FIG. 1B illustrates a cube 100 and a modified cube 110 having the same dimensions, and therefore the same aspect ratios. As defined above, the longest distance along the z-axis may be the height, the longest distance along the y-axis may be the length and the longest distance along the x-axis may be the width. As such, both geometric shapes 100 and 110 illustrated in FIG. 1B have the same height, length and width.

### Boring Capability:

The boring capability of a deicer salt is proportional to its mass to contact surface area ratio. A deicer shaped form according to present invention has a plurality of planar surfaces. Each surface of the deicer shaped form may be the contact surface. A contact surface is defined as the surface on which the deicer shaped form can rest on the icy surface. The deicer salt shaped form may be distributed on the icy surface manually or mechanically. Upon contacting the icy surface, the deicer salt shaped form may tumble multiple times before coming to rest on one of multiple planar surfaces. The surface on which the deicer salt shaped form stands becomes the contact surface. If the deicer salt shaped form is an equal-sided shape, such as a cube, then all contact surfaces will be approximately the same area and dimensions. If the deicer salt shaped form is another shape, such as for example a pyramid, then four sides will be triangular and one side will be square, but all five sides may be considered a contact surface, yet each shape has different area and/or dimensions. Each deicer salt shaped form with planar sides according to the present invention has a mass to contact surface area ratio that allows it to bore deep though the ice or snow surface. An exemplary deicer salt shaped form manufactured according to the present invention having the same mass as a conventional deicer flake will have a smaller contact surface area than the contact surface area of the conventional deicer flake. As a result, the mass to contact surface area ratio of the exemplary deicer salt shaped form will be greater than the mass to contact surface area ratio of the conventional deicer flake. Thus, the exemplary deicer salt shaped form will bore deeper through the ice or snow surface because the mass of the exemplary deicer salt shaped form will be concentrated over the contact surface. The boring capability allows the deicer to penetrate more effectively so that the melting can start from the lower layer of the snow or ice accumulation, promoting ice breakage and melting.

### Uniform Shape:

The deicer salt shaped forms according to the present invention may be manufactured using mold cavities having a uniform predetermined geometric shape. Thus, the deicer salt shaped forms have a uniform shape and can also have a uniform consistency. As used herein, “uniform” refers to a shape that is consistently reproduced to have predetermined shape, size, dimensions, and material characteristics, so as to be substantially the same from one particle to another. This differs from conventional deicer particles, such as spheroids that are not consistently round and have different sizes, or a randomly shaped granule where each particle is uniquely shaped and dimensioned, or a randomly shaped and sized flake resulting from breaking up a sheet of material.

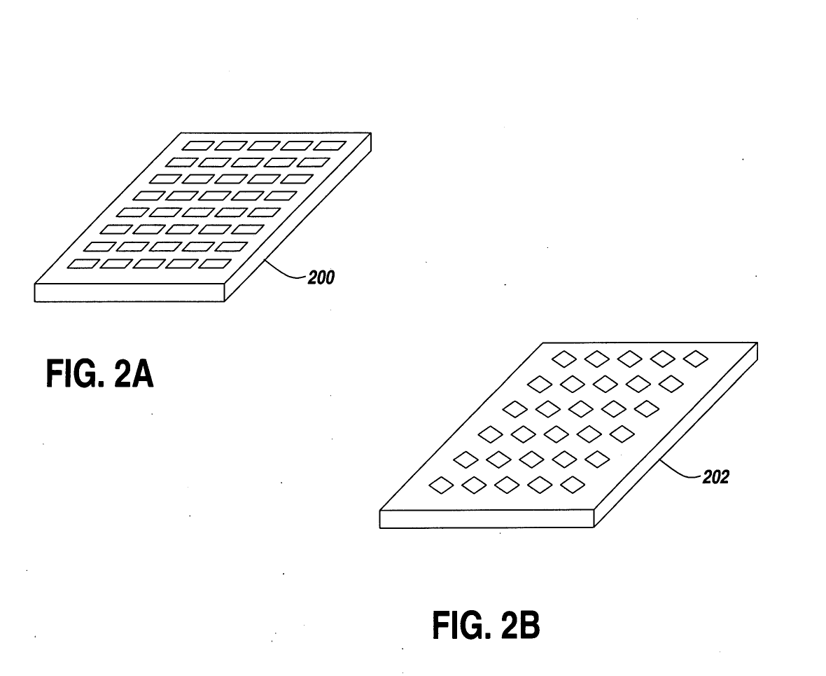

FIGS. 2A and 2B illustrate two exemplary mold systems according to various embodiments of the present invention. FIG. 2A illustrates an exemplary mold 200 having a plurality of cavities in the shape of cubes. FIG. 2B illustrates an exemplary mold 202 having a plurality of cavities in the shape of parallelepipeds. According to an exemplary embodiment of the present invention, these molds may be filled with a liquid deicer salt solution that can melt ice and/or snow. The liquid deicer salt solution is hardened to form the solid deicer salt shaped forms. The deicer salt shaped forms are then extracted from the molds. The molds may be flexible for easy extraction of the solid deicer salt shaped forms. Alternatively, the molds may be first covered with a material that does not impair the formation of the deicer shaped forms while allowing the shaped forms to be easily extracted from the molds.

According to another exemplary embodiment of the present invention, fine particles of deicer salt composition that can melt ice or snow may be compacted into the mold cavities illustrated in FIGS. 2A and 2B. The compacted fine particles of deicer salt composition take the shape of the solid deicer salt shaped forms within the mold cavities. The deicer salt shaped forms are then extracted from the molds, forming uniform predetermined shapes.

As indicated above, deicer salt shaped forms produced according to the present invention have a uniform shape and uniform mass. The uniform shape of the deicer salt shaped forms can be designed to be of a particular shape and size to reduce the risk of jamming the equipment that spreads the deicer salt particles on the icy surface. The equipment for spreading the deicer salt particles, e.g. a mechanical spreader, has an opening for the particles to be pushed out of the equipment. If the deicer salt particles are of a uniform shape and size, the opening may be shaped and sized according to the particular shape and size of the uniform deicer salt particles, resulting in a pairing of deicer salt shaped form and spreader device opening that operate together to avoid jamming. In contrast, if the particles are not uniform, the opening must be sized and shaped so as to allow the largest particles to pass through. However, the opening can be too large for some particles, resulting in many particles fitting through the opening at the same time and causing uneven application and potential jamming of the equipment; or the opening can be too small for some other particles, resulting in large particles getting stuck at the opening and jamming the equipment. In contrast, the uniform deicer salt particles of the present invention can be designed and consistently manufactured to be less likely to jam the equipment that has an opening shaped and sized to operate in conjunction with uniform deicer salt shaped forms of a predetermined size and shape.

### Drag Coefficient:

The drag coefficient of an object determines its resistance to air, e.g. to wind, while airborne. A higher drag coefficient will result in more aerodynamic drag. Therefore, an object with higher drag coefficient will have its motion through a fluid, such as air, impacted more by the fluid. Table-1 illustrates drag coefficients for various known geometric shapes. As illustrated in Table-1, a sphere, such as a spheroid deicer, has a much lower drag coefficient than a cube or angled cube, such as a cubical deicer. Deicer salt shaped forms produced according to the present invention have a drag coefficient greater than 0.47. However, it should be noted that a higher drag coefficient for a shaped form with a relatively lower total mass can result in the form being susceptible to being blown around by wind. Therefore, as discussed herein, the present invention strives to find an appropriate balance between multiple characteristics such as these.

TABLE 1
Measured Drag Coefficients

| | Drag |
|---|---|
| Shape | Coefficient |
| 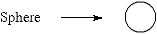 | 0.47 |
| 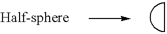 | 0.42 |
| 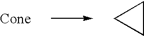 | 0.50 |
| 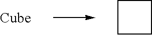 | 1.05 |
| 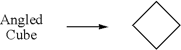 | 0.80 |
| 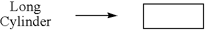 | 0.82 |
| 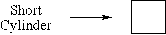 | 1.15 |
| 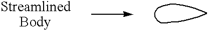 | 0.04 |
| 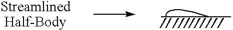 | 0.09 |

### Resistance to Roll:

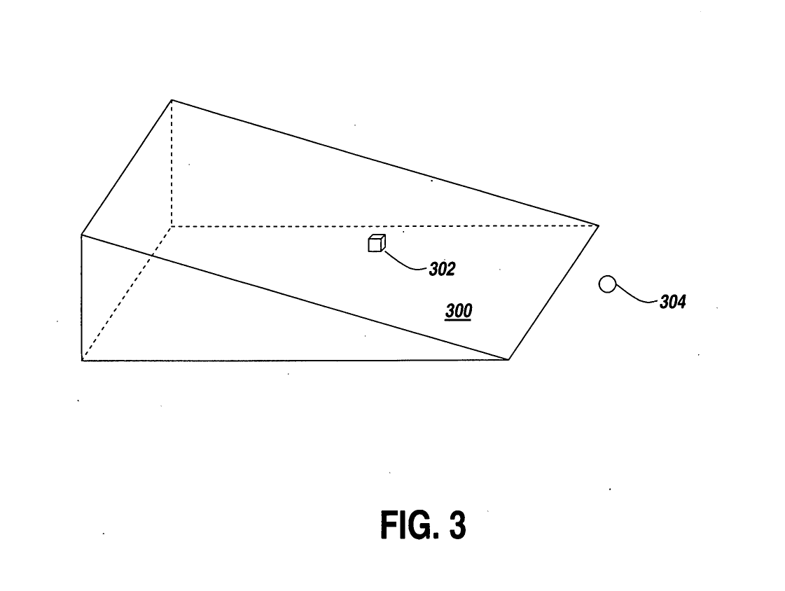

One of the characteristics of the deicer salt shaped forms is the resistance to rolling on inclined surfaces. When the deicer salt shaped form is thrown on an icy and/or snowy surface, one of the planar surfaces of the deicer salt shaped form becomes the contact surface. The deicer salt shaped form stays on the planar contact surface and does not roll off an inclined surface as a conventional spheroid deicer salt would. FIG. 3 illustrates a performance test comparing the solid deicer salt shaped form 302 according to the present invention and a spheroid deicer salt particle 304 dropped from a pre-determined height on an inclined surface 300 to measure resistance to rolling on the inclined surface 300. The test duplicates conditions typically found during deicing applications in winter weather. Both deicers, i.e. the solid deicer salt shaped form 302 and the spheroid deicer 304, are dropped from a height of 6″ onto a surface 300 that is inclined at an angle of 5°, a common angle found on driveways and sidewalks in many areas. Upon hitting the surface, the spheroid deicer 304 rolls off the surface 300. In contrast, the solid deicer salt shaped form 302 comes to rest on one of its plurality of planar surfaces. The test was repeated several times with identical results.

### Resistance to Wind:

Another characteristic of the deicer salts is the resistance to wind. The deicer salt particles must be resistant to wind while airborne, so that the particles will be spread only to the intended area, and not blown considerable distances through the air. This is achieved by not having a large flat side with a thin edge (such as a flake) which results in a large contact surface relative to an overall mass or weight of a particular salt particle. Such a shape can act like a sail and experience lift and excess movement by wind. The deicer salt particles must also be resistant to wind once they have landed on the icy surface so that they can stay on the surface to effect deicing. When the deicer salt shaped form is thrown on an icy and/or snowy surface, one of the planar surfaces of the deicer salt shaped form becomes the contact surface area. Wind resistance tests performed on the solid deicer salt shaped form in the shape of a cube according to the present invention show that the solid deicer salt shaped form lands on one of the plurality of planar surfaces and stays stable on the contact surface at all wind speeds up to 4.9 mph when dropped from a height of 6″. When the wind speed is between 4.9 to 8.1 mph, the solid deicer salt shaped form bounces and tumbles on the surface one or two times and stays stable in place, resisting to the surface wind up to 8.1 mph. The solid deicer salt shaped forms remains stable on the surface even when the surface wind speed is increased to 12.3 mph.

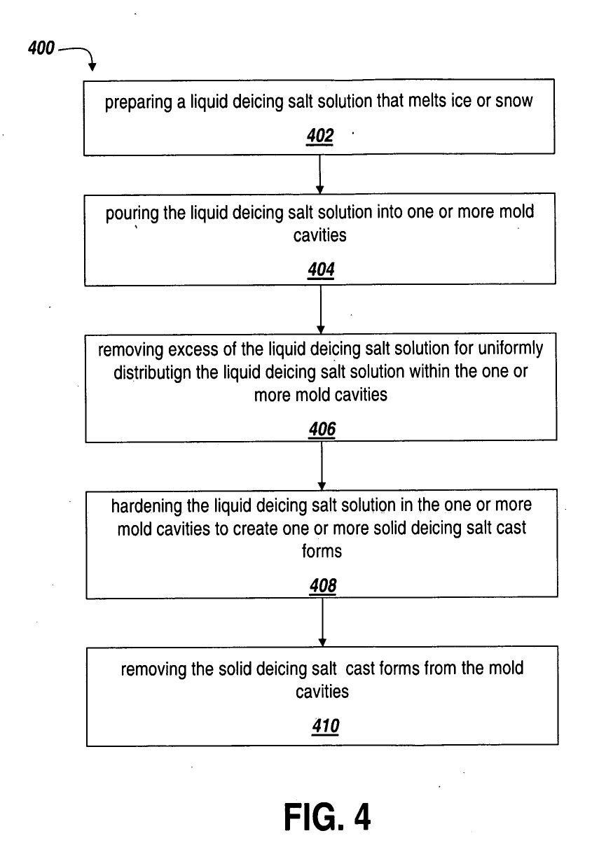

FIG. 4 illustrates a flowchart 400 of steps of manufacturing the solid deicer salt shaped forms according to an exemplary embodiment of the present invention. First, a liquid deicer salt solution is prepared (step 402). The liquid deicer salt solution is then poured into one or more mold cavities having a predetermined geometric shape such as a cube, a pyramid or a parallelepiped (step 404). An excess of the liquid deicer salt solution is removed from each one of the mold cavities, for example by using a tool similar to a squeegee, uniformly distributing the liquid deicer salt solution in the mold cavities (step 406). The liquid deicer salt solution is hardened, for example by drying, to create one or more solid deicer salt shaped forms within the one or more mold cavities (step 408). The one or more solid deicer salt shaped forms are then removed from the mold cavities (step 410).

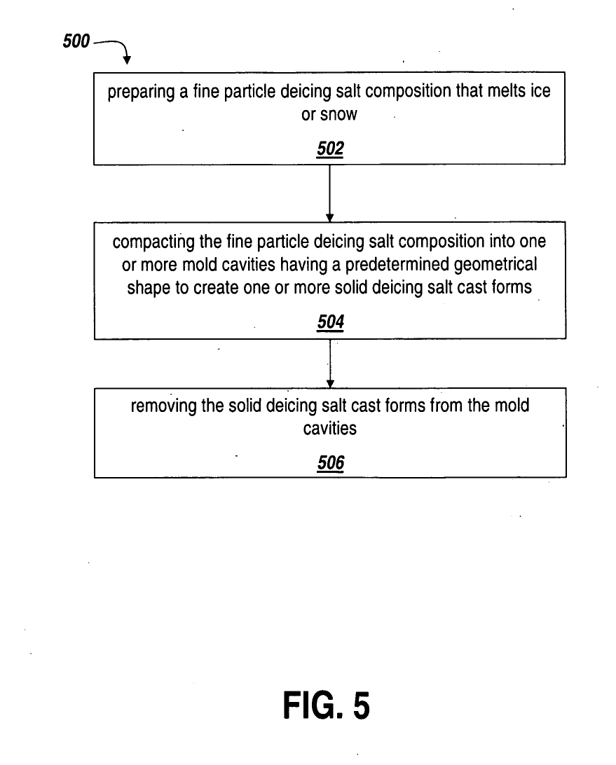

The present invention is not limited to solidifying a liquid deicer salt solution to obtain solid deicer salt shaped forms. According to another embodiment of the present invention, fine deicer salt particles may be compacted into solid deicer salt shaped forms. FIG. 5 illustrates a flowchart 500 of steps for manufacturing the solid deicer salt shaped forms from fine deicer salt particles. First, a fine particle deicer salt composition is prepared (step 502). The fine particle deicer salt composition is compacted into one or more mold cavities that have a predetermined geometric shape such as a cube, a pyramid, or a parallelepiped, to create one or more solid deicer salt shaped forms (step 504). The solid deicer salt shaped forms are then removed from the mold cavities (step 506).

The manufacturing methods for the solid deicer salt shaped forms described above are for illustrative purposes only and should not be construed as limiting. Additional methods to manufacture the solid deicer salt shaped forms are also considered to fall within the scope of the present invention. For example, the above described methods or modifications thereof may be implemented in mass production. The one or more mold cavities may be provided on a conveyor belt. The belt may then be flooded with the liquid deicer salt solution. The belt may go through a cooling process to create the solid deicer salt shaped forms in the one or more mold cavities. The solid deicer salt shaped forms may be removed from the mold cavities at the end of the belt.

Alternatively, the solid deicer salt shaped forms may be produced through agglomeration. In one exemplary implementation of agglomeration, two rotating drums facing each other mash the material provided between the drums. For example, a fine particle deicer salt composition may be provided between two rotating drums. The drums may have surface features, e.g. protrusions and/or recesses, similar to a golf ball. The fine particle deicer salt composition is compacted into a thick sheet and cut into pieces having a predetermined geometric shape; or the protrusions and recesses can generate the predetermined shapes and a thin resulting connective layer between each shape can be removed or cut away, leaving the desired predetermined shapes.

According to an example embodiment, the solid deicer salt shaped forms may be produced by extrusion. The fine deicer salt particles may be compacted into an elongated rectangular shape, such as an elongated rectangular tube. Alternatively, the liquid deicer salt solution may be solidified using a mold having an elongated rectangular shape, such as an elongated rectangular tube. The elongated rectangular shape may be then cut into pieces having a predetermined geometric shape to obtain the solid deicer salt shaped forms. One of ordinary skill in the art will appreciate that there are numerous manufacturing processes that can take either a brine solution or a powder material and form them into the predetermined uniform shaped forms in accordance with the present invention.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the invention, and exclusive use of all modifications that come within the scope of the appended claims is reserved.

What is claimed is:

1. A deicer salt shaped form comprising:
a pre-determined three dimensional geometric shape having aspect ratios of length to width, length to height, and width to height, each between about 0.5 and about 1.5,
wherein the deicer salt shaped from is adapted to melt snow and ice.

2. The deicer shaped form of claim 1, wherein the deicer salt shaped form further comprises a plurality of planar surfaces, wherein each planar surface has a drag coefficient greater than 0.47.

3. The deicer salt shaped form of claim 2, wherein the deicer salt has a contact surface area between 9 mm² and 36 mm², wherein the contact surface area is one of the plurality of planar surfaces on which the deicer salt shaped form rests stable on a surface to be deiced.

4. The deicer salt shaped form of claim 1, wherein the pre-determined geometric shape is one of a cube, a pyramid and a parallelepiped.

5. The deicer salt shaped form of claim 1, wherein the deicer salt shaped form has a volume of about 25-225 mm³.

6. The deicer salt shaped form of claim 1, wherein the deicer salt has a volume of about 64 mm³.

7. A method of preparing a deicer salt shaped form, the method comprising:
providing at least one mold cavity having a geometric shape;
introducing a liquid deicer salt solution into the at least one mold cavity;
hardening the liquid deicer salt solution in the at least one mold cavity to create the deicer salt shaped form; and
removing the deicer salt shaped form from the at least one mold cavity.

8. The method of claim 7, wherein the geometric shape is one of a cube, a pyramid and a parallelepiped.

9. The method of claim 7, wherein the geometric shape has a plurality of planar surfaces.

10. The method of claim 8, wherein a drag coefficient of each of the plurality of planar surfaces is greater than 0.47.

11. The method of claim 7, wherein the deicer salt shaped form has a volume of about 25-225 mm³.

12. The method of claim 7, wherein the deicer salt shaped form has a contact surface area between 9 mm² and 36 mm², the contact surface area being the surface area of the deicer salt shaped form upon which the deicer salt shaped form rests.

13. The method of claim 12, wherein the contact surface area is about 16 mm².

14. The method of claim 7, further comprising, after introducing the liquid salt solution into the mold cavity, removing excess of the liquid salt solution for uniformly dispersing the liquid salt solution within the mold cavity.

15. The method of claim 7, wherein the at least one mold cavity is flexible.

16. The method of claim 7, further comprising, providing a mold system comprising a plurality of mold cavities each having a geometric shape.

17. The method of claim 16, wherein the mold system is flexible.

18. A method of preparing a deicer salt shaped form having a predetermined shape, the method comprising:
providing at least one mold cavity having a geometric shape including a cube, a pyramid or a parallelepiped;
compacting a fine particle deicer salt composition into the at least one mold cavity to create the deicer salt shaped form; and
removing the deicer salt shaped form from the at least one mold cavity.

19. The method of claim 18, wherein each surface of the solid shaped form has a volume of about 25-225 mm³.

20. The method of claim 18, further comprising, providing a mold system comprising a plurality of mold cavities each having a geometric shape.

21. A deicer salt shaped form comprising:
a first substantially planar surface formed in a predetermined shape having predetermined size and dimensions;
a second substantially planar surface formed in a predetermined shape having predetermined size and dimensions and intersecting with the first substantially planar surface;
a third substantially planar surface formed in a predetermined shape having predetermined size and dimensions and intersecting with at least the first substantially planar surface and the second substantially planar surface;
a fourth substantially planar surface formed in a predetermine shape having predetermined size and dimensions and intersecting with at least one of the first, the second, or the third substantially planar surfaces;
wherein the first, the second, the third, and the fourth substantially planar surfaces combine to form at least a portion of a pre-determined three dimensional geometric shape;
wherein the three dimensional geometric shape has aspect ratios of length to width, length to height, and width to height, each between about 0.5 and about 1.5; and
wherein the three dimensional geometric shape is adapted to melt snow and ice.
